(19) United States
(12) Patent Application Publication
(10) Pub. No.: US 2023/0018995 A1
(43) Pub. Date: Jan. 19, 2023

(54) NEURAL STYLE TRANSFER BASED SLIDER PUZZLE CAPTCHA

(71) Applicant: Zoho Corporation Private Limited, Chengalpattu Taluk (IN)

(72) Inventors: Sujatha S. Iyer, Chengalpattu Taluk (IN); Balachandar S., Chengalpattu Taluk (IN); Ramprakash Ramamoorthy, Chengalpattu Taluk (IN); Shailesh Kumar, Chengalpattu Taluk (IN)

(21) Appl. No.: 17/836,552

(22) Filed: Jun. 9, 2022

Related U.S. Application Data
(60) Provisional application No. 63/235,551, filed on Aug. 20, 2021.

(30) Foreign Application Priority Data
Jun. 11, 2021 (IN) 202141026109

(51) Int. Cl. G06F 21/36

(52) U.S. Cl. CPC G06F 21/36; G06F 2221/2133

(57) ABSTRACT

Two CAPTCHA variants based on neural style transferred image are described: an option-based CAPTCHA and a slider-based CAPTCHA. In the neural style transfer-based slider puzzle CAPTCHA, a neural style transferred image is used as the background. Multiple missing blocks and a puzzle block to be moved are embedded on the neural style transferred image. The user is presented with a slider, using which they can drag the sliding block and place it on the correct missing block. Since the background image is neural style transferred, it becomes difficult to decipher the original image due to high difference in the texture. Placing multiple missing blocks makes the system more resilient to attacks because the chances of finding the correct missing block position is decreased. In the option-based neural style transfer image CAPTCHA, a neural style transferred image of an object/animal is presented to the user along with multiple options. The user is asked to select the option that best describes the presented image. A neural style transferred image helps the CAPTCHA to be more resilient to automated attacks, since the ability of image being reverse searched and answered is less.

### CROSS-REFERENCE TO RELATED APPLICATIONS

This application claims priority to Indian Provisional Patent Application No. 202141026109 filed Jun. 11, 2021, U.S. Provisional Patent Application Ser. No. 63/235,551 filed Aug. 20, 2021, and Indian Non-Provisional Patent Application No. 202141026109 filed May 13, 2022, which are hereby incorporated by reference herein.

### BACKGROUND

An example of a Completely Automated Public Turing test to tell Computers and Humans Apart (CAPTCHA) system is reCaptcha, which Google developed to reduce spam. The user is presented an image grid and is asked to select images that match the given description.

CAPTCHA mechanisms have been traditionally used to reduce spam/bot traffic. Most of the CAPTCHA systems involve object identification to tell humans apart. With object recognition techniques getting better day by day, the efficiency of CAPTCHA systems faces an imminent downgrade as CAPTCHA solving can be automated by using object recognition tools.

### SUMMARY

With object recognition tools getting better day by day, the ability to crack a Completely Automated Public Turing test to tell Computers and Humans Apart (CAPTCHA) also becomes higher. The idea behind using neural style transfer is to exploit the shape bias of human eyes to ensure it is a human who is solving the CAPTCHA and not a bot/automation tool. Human eyes carry a shape bias whereas object recognition engines carry a texture bias. When neural style transfer is applied to an image, it results in an inherent change in the texture of the image.

A CAPTCHA containing a neural style transferred image with multiple hollow blocks and a missing block are presented to a user. The user must drag the header of a range slider to place the missing block in the correct hollow block to solve the CAPTCHA. Once the user has finished dragging the header of the slider, the evaluation is done.

Applying neural style transfer to the background image, makes it difficult to find out the original image because of high difference between the two images (i.e., original image vs neural style transferred image) thus offering increased protection against automated attacks. Placing multiple hollow blocks greatly reduces the probability of guessing a correct hollow block by automation tools thus making the CAPTCHA system much more resilient to automated attacks.

### BRIEF DESCRIPTION OF THE DRAWINGS

FIG. 1 depicts an image of an example of Neural style transfer-based slider puzzle Completely Automated Public Turing test to tell Computers and Humans Apart (CAPTCHA).

FIG. 2 depicts a diagram of an example of a CAPTCHA engine architecture.

FIG. 3 depicts an example of a content image.

FIG. 4 depicts an example of a style image.

FIG. 5 depicts an example of a Neural style transferred image.

FIG. 6 depicts a block diagram showing an example of an architecture of neural style transfer engine.

FIG. 7 depicts a data flow diagram illustrating an example of a CAPTCHA validation process.

FIG. 8 depicts a flowchart illustrating an example of a CAPTCHA solving process on client side.

FIG. 9 depicts a flowchart illustrating an example of a CAPTCHA validation process on server side.

FIG. 10 depicts an example of Option-based Neural Style Transfer Image CAPTCHA.

### DETAILED DESCRIPTION

Generally, human eyes carry a shape bias, e.g., a human eye recognizes a butterfly because of its shape (for example, recognizing a butterfly because of its wings). Whereas object recognition/image search tools recognize an object based on its texture. When neural style transfer is applied to an image, it brings about a change in the texture of the image, which makes it difficult for object recognition/image search tools to identify them.

Completely Automated Public Turing test to tell Computers and Humans Apart (CAPTCHA) is a program or system intended to distinguish human from machine (e.g., bot) input, typically as a way of thwarting spam and automated extraction of data from websites. As used in this paper, CAPTCHA can refer to the visual elements presented to a user in a graphical user interface (GUI) for the purpose of distinguishing human from machine input in response to user actions taken in association therewith.

The techniques described in this paper can be used to prevent spam in Identity and Access Management (IAM). For example, on a login page, a signup page, or other places where spam filtering may be desirable. Presenting a CAPTCHA when a user tries to login/sign up greatly reduces spam. When a user tries to login, a CAPTCHA will be presented after they enter their credentials (e.g., username and password). This can make a login portal more resilient to automated attacks because neural style transferred image-based CAPTCHA are difficult to crack using object recognition tools.

The techniques described in this paper can also be used to prevent spam record being filled up in an application development platform (e.g., ZOHO Creator), a form creation platform (e.g., ZOHO Forms), a review platform (e.g., ZOHO Survey), or the like. Presenting a CAPTCHA before submission of an entry helps prevent spam/junk records being filled up because of automated attacks.

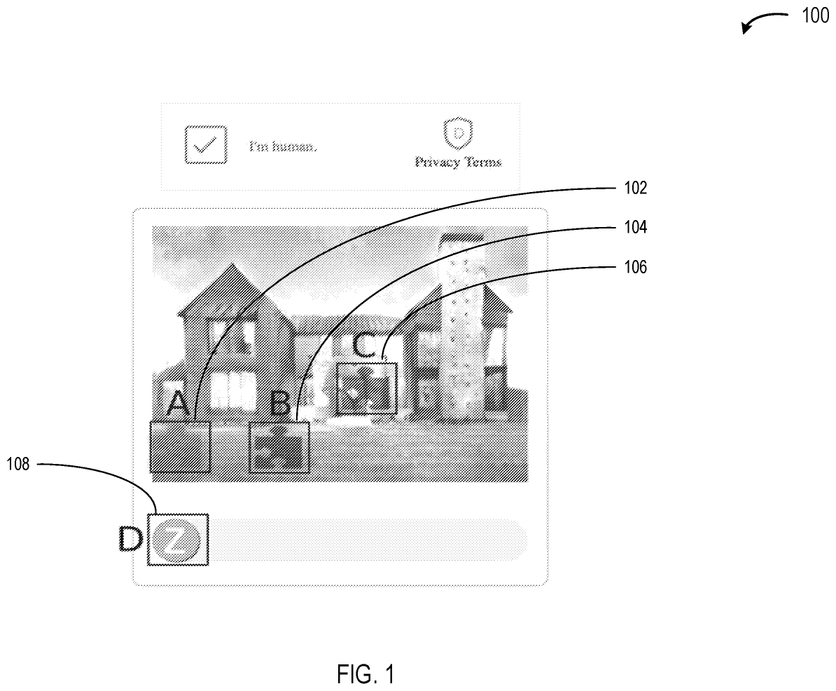

FIG. 1 depicts an image 100 of an example of Neural style transfer-based slider puzzle CAPTCHA. The image 100 includes a missing block A (102), a correct hollow block B (104), an incorrect hollow block inserted to confuse attackers C (106), and a horizontal range slider D (108).

A CAPTCHA containing a neural style transferred image, such as the image 100, with two hollow blocks and a missing block are presented to a user. To solve the CAPTCHA, the user drags an active element (e.g., a header or handle) of the horizontal range slider D which will result in moving the missing block A towards correct hollow block B to coincide with the correct hollow block B. To protect the CAPTCHA from attackers trying to guess the missing block position, two hollow blocks are introduced in the image of which only one block's position is correct; in FIG. 1, incorrect hollow block C is added to confuse attackers and protect the system from automated attacks. Once the user has finished dragging the header of the slider, the evaluation is done.

Applying neural style transfer to a background image makes it difficult to find out the original image because of high difference between the two images (e.g., original image vs neural style transferred image) thus offering increased protection against automated attacks. Placing two hollow blocks greatly reduces the probability of guessing the correct hollow block by automation tools thus making the CAPTCHA system much more resilient to automated attacks.

In this example, the change in movement is only horizontal, but in an alternative, the slider is a vertical range slider, a 2-dimensional range slider, a 3-dimensional range slider, or a slider of some other dimension. In other alternatives, the slider is replaced with some other active element that, when engaged, enables the user to move a missing block to a hollow block.

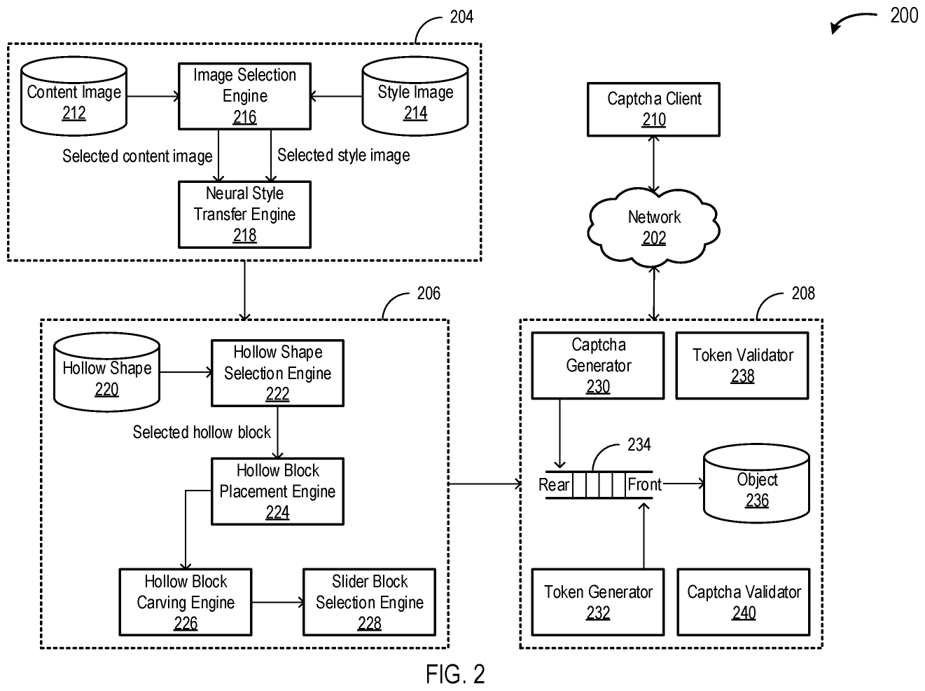

FIG. 2 depicts a diagram 200 of an example of a CAPTCHA engine architecture. The diagram 200 includes a network 202, a CAPTCHA image generator 204, a CAPTCHA puzzle generator 206, a CAPTCHA server 208, and a CAPTCHA client 210. The CAPTCHA image generator 204 and the CAPTCHA puzzle generator 206 may be implemented “server-side,” either in a distributed fashion or co-located on a device that includes the CAPTCHA server 208. In an alternative, one or more of the network 202, CAPTCHA image generator 204, CAPTCHA puzzle generator 206, CAPTCHA server 208, and CAPTCHA client 210 are co-located on a device (and to the extent “server” and “client” components are co-located, they would likely be referred to as something other than “server” and “client”).

The network 202 and other networks discussed in this paper are intended to include all communication paths that are statutory (e.g., in the United States, under 35 U.S.C. 101), and to specifically exclude all communication paths that are non-statutory in nature to the extent that the exclusion is necessary for a claim that includes the communication path to be valid. Known statutory communication paths include hardware (e.g., registers, random access memory (RAM), non-volatile (NV) storage, to name a few), but may or may not be limited to hardware.

The network 202 and other communication paths discussed in this paper are intended to represent a variety of potentially applicable technologies. For example, the network 202 can be used to form a network or part of a network. Where two components are co-located on a device, the network 202 can include a bus or other data conduit or plane. Where a first component is co-located on one device and a second component is located on a different device, the network 202 can include a wireless or wired back-end network or LAN. The network 202 can also encompass a relevant portion of a WAN or other network, if applicable.

The devices, systems, and communication paths described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

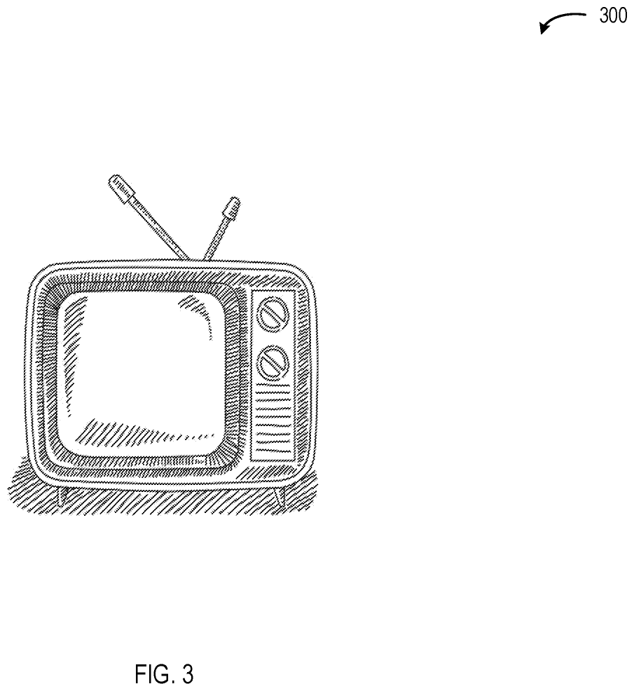

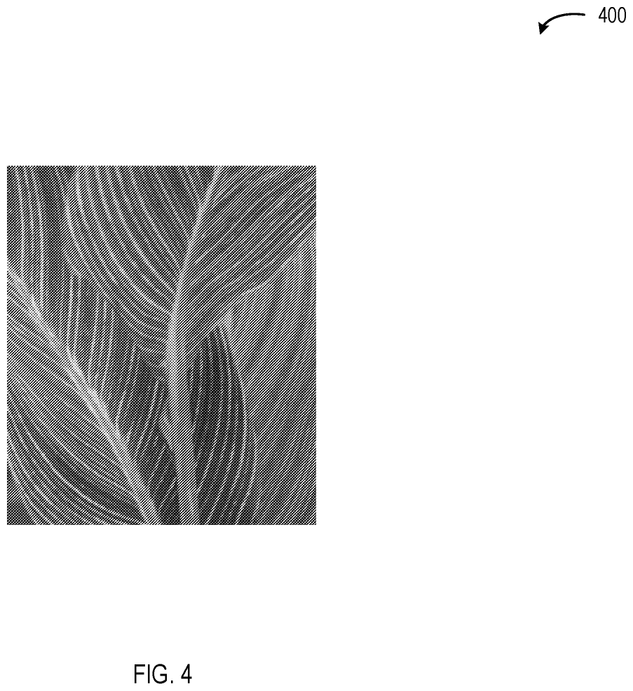

Returning to the example of FIG. 2, the CAPTCHA image generator 204 includes a content image datastore 212, a style image datastore 214, an image selection engine 216, and a neural style transfer engine 218. The content image datastore 212 is intended to represent a datastore that includes one or more images of an object whose texture/style is to be changed for inclusion in a neural style transferred image. The style image datastore 214 is intended to represent a datastore that includes one or more images with a distinct texture having stylistic properties that will be transferred to the content image by the neural style transfer engine 218 for inclusion in a neural style transferred image. A sample content image and a style image are shown in FIGS. 3 and 4, respectively.

A database management system (DBMS) can be used to manage a datastore. In such a case, the DBMS may be thought of as part of the datastore, as part of a server, and/or as a separate system. A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2,Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 2, the image selection engine 216 is intended to represent an engine that picks a content image from the content image datastore 212 and a style image from the style image datastore 214 and ensures avoiding repetition of images. In a specific implementation, this results in the generation of different CAPTCHA images every time.

A computer system can be implemented as an engine, as part of an engine or through multiple engines. As used in this paper, an engine includes one or more processors or a portion thereof. A portion of one or more processors can include some portion of hardware less than all the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor that is a component of the engine. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

Returning to the example of FIG. 2, the content image and style image selected by the image selection engine is fed to the neural style transfer engine 218. The neural style transfer engine is intended to represent an engine that generates a neural style transferred image. Neural style transfer is essentially an image generation technique. It takes a pair of images as input, namely content image and style image. Given a pair of content and style images, the task here is to generate a new image which is essentially the content image carrying the characteristics of the style image. The generated image will have a change in the texture which plays a key role in tackling object recognition systems.

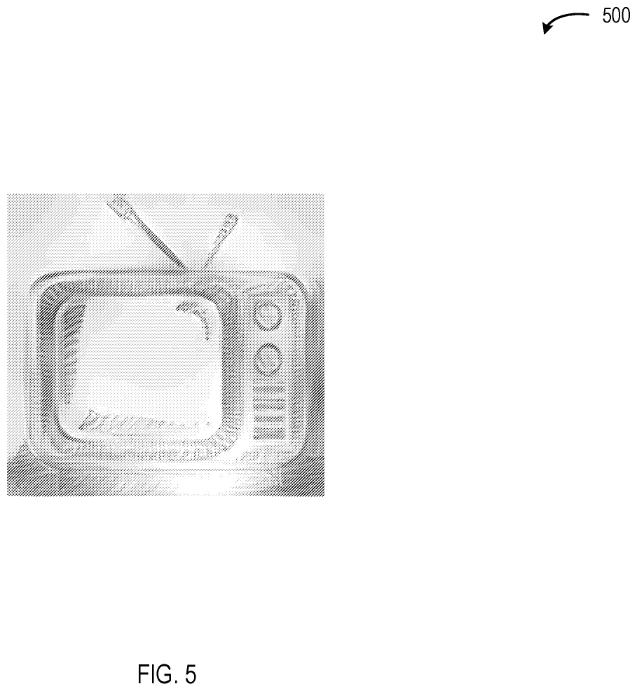

Neural style transfer introduces a difference between the original image and the style transferred image due at least in part to change in texture. This helps reduce attack surface as it becomes difficult to find out the original image (original content image). A sample neural style transferred image is shown in FIG. 5.

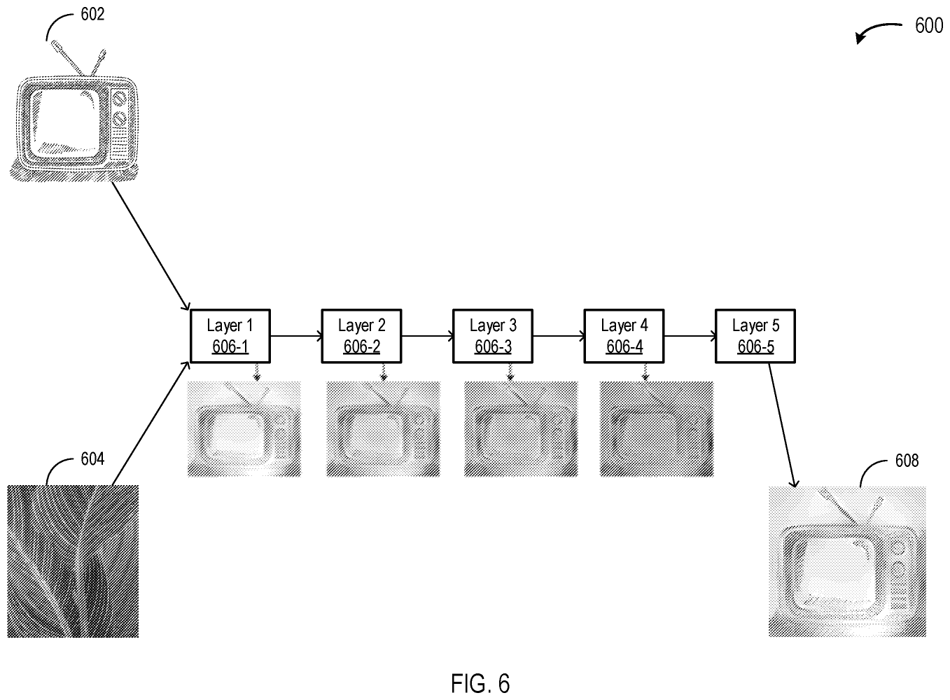

FIG. 6 depicts a block diagram 600 showing an example of an architecture of neural style transfer engine. The example is suitable for use as the neural style transfer engine 218 of FIG. 2. In a specific implementation, the neural style transfer engine includes a 5-layer of Visual Geometry Group (VGG)-19 encoder and decoder with Rectified Linear Unit (ReLU) as the activation function. It deploys a simple yet effective method for universal style transfer, which enjoys the style-agnostic generalization ability with marginally compromised visual quality and execution efficiency. The transfer task is formulated as image reconstruction processes, with the content features being transformed at intermediate layers with regard to the statistics of the style features, in the midst of feed-forward passes. In each intermediate layer, the extracted content features are transformed such that they exhibit the same statistical characteristics as the style features of the same layer. Classic signal whitening and coloring transforms (WCTs) have been applied on those features to achieve this goal in an almost effortless manner. The features are extracted from a content image 602 (in the example of FIG. 6, the content image 602 is the one provided by way of example in FIG. 3) and style image 604 (in the example of FIG. 6, the style image is the one provided by way of example in FIG. 4). The features of the content image are subjected to whitening and color transformation. The transformed features are then mixed with the features extracted from style image resulting in the neural style transferred image.

Input for layer 1 (606-1) is a content image and a style image. When neural style transfer is applied to content images, the properties of the style image are transferred to the content image to change its texture. This makes it difficult for object recognition engines to identify objects because object recognition systems primarily identify an image based on texture. (A human primarily identifies, e.g., a butterfly because of the presence of wings, body etc.).

Input to layer 2 (606-2), which is output from layer 1, is a preliminary neural style transferred image that comprises the content image modified by having stylistic properties from the style image transferred to the content in layer 1. In a specific implementation, the layers do not carry a texture bias, but they learn how to transfer the stylistic properties as the preliminary neural style transferred image passes through the layers and is modified. Thus, stylistic properties are better transferred to the content image after layer 2 compared to after layer 1, after layer 3 (606-3) compared to after the earlier layers, and after layer 4 (606-4) compared to after the earlier layers.

In the example of FIG. 6, the output of layer 5 (606-5) is a neural style transferred image 608 (in the example of FIG. 6, the neural style transferred image 608 is the one provided by way of example in FIG. 5).

Referring once again to the example of FIG. 2, the CAPTCHA puzzle generator 206 includes a hollow block shape datastore 220, a hollow shape selection engine 222, a hollow block placement engine 224, a hollow block carving engine 226, and a slider block selection engine 228. The hollow block shape datastore 220 includes one or more block shapes that can be applied to a neural style transferred image.

The hollow shape selection engine 222 is intended to represent an engine that selects a puzzle block shape from the hollow block shape datastore 220. In a specific implementation, the selection is pseudo-random. In an alternative, the puzzle block shapes can be procedurally generated.

The hollow block placement engine 224 is intended to represent an engine that selects multiple positions on the neural style transferred image. In a specific implementation, the hollow block placement engine 224 selects two positions that are fixed apart from each other.

The hollow block carving engine 226 is intended to represent an engine that carves multiple puzzle blocks on the neural style transferred image. In a specific implementation, the hollow block carving engine 226 carves out two different puzzle blocks on the neural style transferred image, leaving behind two corresponding hollow blocks. See, e.g., correct hollow block B (104) and incorrect hollow block C (106) in FIG. 1, for which the position of the hollow blocks corresponds to the positions selected by the hollow block placement engine 224 and the shape of the puzzle blocks and their respective hollow blocks correspond to the shape selected by the hollow shape selection engine 222. In a specific implementation, the hollow blocks carved out are debossed in nature, e.g., the missing hollow blocks B (104) and C (106) are translucent. This helps in reducing the attack surface as it becomes difficult to find out regions of missing block due to reduced pixel differences.

The slider block selection engine 228 is intended to represent an engine that selects one of the puzzle blocks as a matching missing block. See, e.g., missing block A (102) in FIG. 1. The unselected one or more puzzle blocks are eventually discarded.

The CAPTCHA server 208 includes a CAPTCHA generator 230, a token generator 232, a CAPTCHA queue 234, a CAPTCHA object datastore 236, a token validator 238, and a CAPTCHA validator 240. The CAPTCHA server 208 is intended to represent an engine that carries out a CAPTCHA process in association with the CAPTCHA client device 210 using a neural style transferred image. The term “server” used in the CAPTCHA server 208 corresponds to “client” used in the CAPTCHA client device 210, but the techniques could be implemented on a system that does not utilize a client-server paradigm and/or in a system in which servers act as clients for other client-server pairs and clients act as servers for other client-server pairs.

The CAPTCHA generator 230 is intended to represent an engine that generates a CAPTCHA which is comprised of a neural style transferred image with at least a missing block A, a correct hollow block B and an incorrect hollow block C. In a specific implementation, when the CAPTCHA is displayed to a user of the CAPTCHA client device 210, the missing block is placed parallel to the header of the horizontal range slider and inline to the correct hollow block B on the neural style transfer image; the missing block A is moved towards the correct hollow block B as the user drags the header horizontally; and the movement of missing block A is coordinated with the movement of the header. The puzzle is solved when the missing block A is superimposed on the correct hollow block B. For example, the header can be dragged horizontally towards correct hollow block B till the missing block A is dropped into the correct hollow block B. The reason for generating two hollow blocks B and C (of which only B is correct) is to confuse attackers who try to find out the hollow block position using automation tools.

Here, “inline” is intended to mean, for a correct answer, the missing block A is dragged to a location above, below, or on the correct hollow block B with a line perpendicular to the range slider passing through the missing block A and correct hollow block B (or to a location above, below, or on the incorrect hollow Block C for an incorrect answer). Similarly, if the slider is vertical, inline means to the left or right of or on the hollow block with a line perpendicular to the vertical slider passing through the missing block and hollow block. In a specific implementation, the header and missing block are linked such that when the header is moved the missing block is moved, but the slider does not pass (using horizontal as an example here) under the hollow block; in this case, it should be understood that the line perpendicular to the range slider means perpendicular to a line parallel to the range slider. For example, the distance the missing block is moved could be a function of the distance the header is dragged (e.g., the missing block could move faster or slower than the header is dragged) so that the header leads or lags behind the missing block when the hollow block is reached. For more exotic sliders, such as spirals, the missing block is more likely to have to be placed directly on the hollow block; in this paper, “inline” is always intended to include the missing block being in, on, under, or overlapping the hollow block.

The token generator 232 is intended to represent an engine that generates a token for a CAPTCHA client unique ID (UID). In a specific implementation, each token corresponds to a solved CAPTCHA and is unique to each client. When a CAPTCHA answer submitted by the user is valid, a token is assigned to the client for the data submission process.

The CAPTCHA queue 234 is intended to represent a datastore of generated CAPTCHAs. In a specific implementation, on server startup, 1000 CAPTCHAs are generated and stored in the CAPTCHA queue 234. The CAPTCHAs and corresponding CAPTCHA answers are stored in the queue. On a client request for CAPTCHA, the CAPTCHA, client UID, and CAPTCHA answer are first transmitted to the object store 236 and then the CAPTCHA is sent to the client.

The token validator 238 is intended to represent an engine that validates. In a specific implementation, the token validator 238 validates the token embedded within the data received from the CAPTCHA client device 210 against the token stored in the object store 236.

The CAPTCHA validator 240 is intended to represent an engine that validates CAPTCHA answers. In a specific implementation, the CAPTCHA validator validates a CAPTCHA answer received from the CAPTCHA client device 210. For example, the CAPTCHA validator can validate a client UID against the object datastore 236. It first checks if a received client UID is present in the object datastore 236. If present, it then proceeds to validate the CAPTCHA answer. It checks if the current slider position (which is same as the distance to which block A has moved from its initial position) coincides with the missing block position. If it coincides, the answer is deemed correct, and the status is indicated to be successful. The status is conveyed to the CAPTCHA client device 210. In case of an incorrect CAPTCHA answer a new CAPTCHA is presented. In case the client UID is not present in the object store, the received client UID is stored in the object datastore 236 and a new CAPTCHA is presented.

The CAPTCHA client device 210 is intended to represent a user device, such as a smartphone, tablet, laptop, desktop computer, or other computing device. The CAPTCHA client device 210 is characterized as a “client” device due to its relationship as a client of the CAPTCHA server 208.

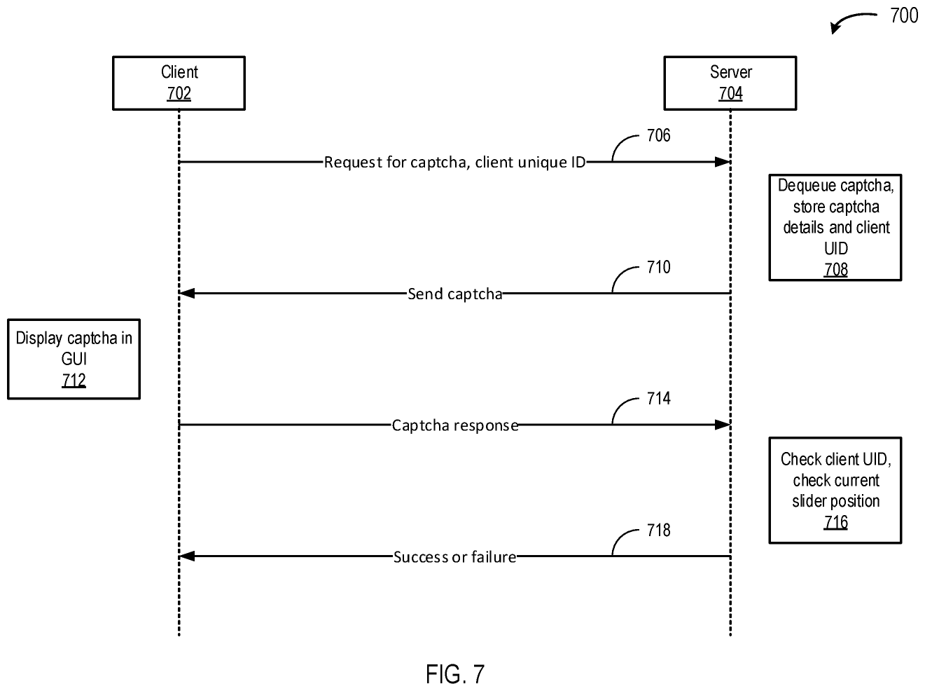

FIG. 7 depicts a data flow diagram 700 illustrating an example of a CAPTCHA validation process. The data flow diagram 700 is of a data flow that takes place between a client 702 (such as the CAPTCHA client device 210) and a server 704 (such as the CAPTCHA server 208). On server startup, a plurality of CAPTCHAs (e.g., 1000) are generated and stored in a CAPTCHA queue (such as the CAPTCHA queue 234). The client 702 sends a request to the server 704 that includes a client UID (706). The server fetches a CAPTCHA by de-queuing it from the CAPTCHA queue; the CAPTCHA, its answer, client's UID, and token are stored in an object data store (such as the object datastore 236) (708). The CAPTCHA is sent to the client (710) and is displayed on a GUI (712). On solving the CAPTCHA, the CAPTCHA's answer is sent to the server (714), which checks the client's UID and validates the CAPTCHA by checking current slider position (716). In case of failure a new CAPTCHA is shown. If the CAPTCHA is valid, then a token is sent to the client. At the time of data submission, the token is validated by the server. If the token is invalid, a new CAPTCHA is presented. If the token is valid, the user is allowed to submit data.

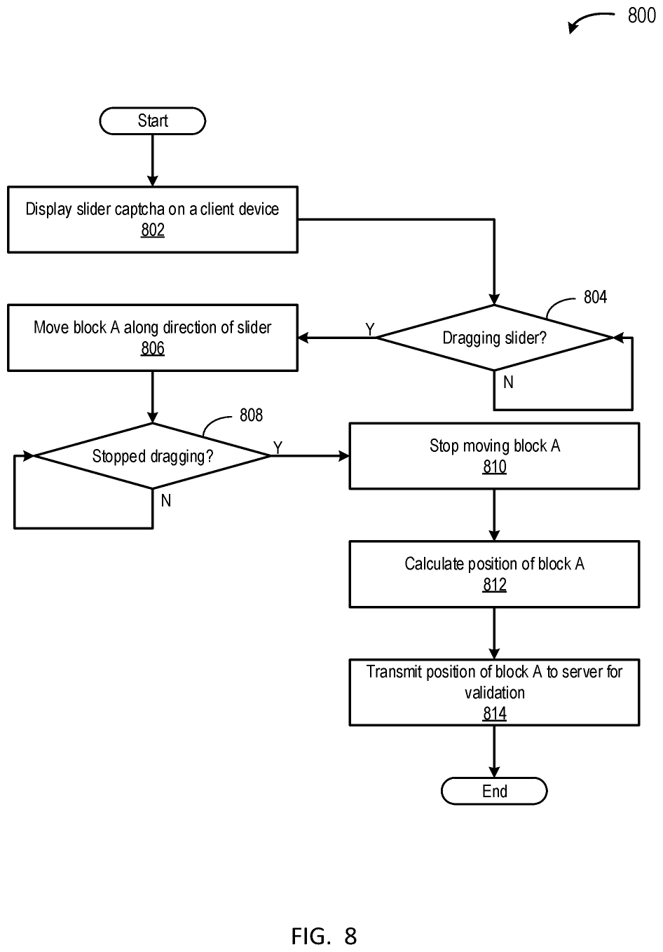

FIG. 8 depicts a flowchart 800 illustrating an example of a CAPTCHA solving process on client side. The flowchart 800 starts at module 802 with displaying a slider captcha on a client device. A range slider is embedded in a CAPTCHA on the client side to facilitate the movement of missing block A. In a specific implementation, the slider enables linear motion of block A in the horizontal direction.

The flowchart 800 continues to decision point 804 where it is determined whether a user of the client device has started to drag the header of the slider. If not (804-N), then the flowchart 800 returns to decision point 804 to await the user's action. For the purposes of this example, it is assumed the user, at some point, begins to drag the header of the slider. When the user does (804-Y), the flowchart 800 continues to module 806 with the block A being moved in the direction of the movement of the header. Slider range increments are correlated with range increments of the distance to the missing block. For example, when a user drags the header of the range slider a range increment horizontally (towards right side), the missing block A also moves a range increment horizontally towards the right side. In a specific implementation, the range increment of the slider and the range increment of the distance to the missing block are a multiple of one another. In an alternative, the range increment of the distance to the missing block is a function of the range increment of the slider (and not simply a multiple).

The flowchart 800 continues to decision point 808 where it is determined whether the user of the client device has stopped dragging the header of the slider. If not (808-N), then the flowchart 800 returns to decision point 808 to await the user's action. For the purposes of this example, it is assumed the user, at some point, stops dragging the header of the slider. Once the user has stopped dragging the header, the flowchart 800 continues to module 810 where the movement of block A is also stopped.

The flowchart 800 continues to module 812 with calculating the current distance of block A (from left hand side) which is equal to a multiple of the distance traversed by the header on the slider. The flowchart 800 ends at module 814 with transmitting a value corresponding to the position of Block A to a server for CAPTCHA validation.

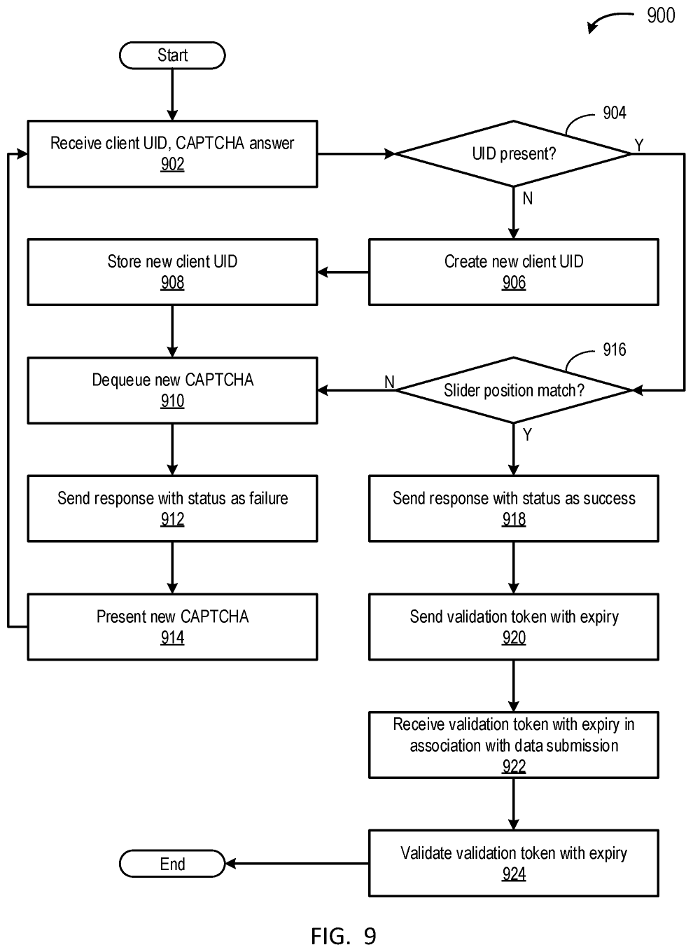

FIG. 9 depicts a flowchart 900 illustrating an example of a CAPTCHA validation process on server side. The flowchart 900 starts at module 902 with receiving a client UID and CAPTCHA answer from a CAPTCHA client device. When a user solves a CAPTCHA, a request is sent to the server to validate the CAPTCHA. The request includes the CAPTCHA answer comprising a slider position and the client's UID. (In case of option-based CAPTCHA, the option chosen and the client's UID is sent).

The flowchart 900 continues to decision point 904 with determining whether the client UID is present in an object datastore (such as the object datastore 236). If it is determined the client UID is not present in the object datastore (904-N), then the flowchart 900 continues to module 906 with creating a new client UID and to module 908 with storing the new client UID in the object datastore. In an alternative, if the client UID does not exist in the object store, the received client UID is written into the object datastore.

The flowchart 900 continues to module 910 with dequeuing a new CAPTCHA from a CAPTCHA queue (such as the CAPTCHA queue 234), continues to module 912 with sending a response to the CAPTCHA client device with a status of failure, continues to module 914 with presenting the new CAPTCHA on the CAPTCHA client device, and returns to module 902 as described previously. The response to the CAPTCHA client device may or may not include the new CAPTCHA. In the examples provided in this paper, the response includes the new CAPTCHA, but it is possible for a response to not include the new CAPTCHA, such as if a CAPTCHA client is timed out due to repeated failures.

If, on the other hand, it is determined the client UID is present in the object datastore (904-Y), then the flowchart continues to decision point 916 where it is determined whether the slider position coincides with a correct missing block (see, e.g., correct hollow block B (104)) in the CAPTCHA with which the CAPTCHA answer is associated. If it is determined the slider position does not coincide with the correct missing block in the CAPTCHA with which the CAPTCHA answer is associated (916-N), then the flowchart 900 returns to module 910 and continues as described previously. When the slider position distance as received from the client does not coincide with the position of the correct missing block B, as stored in the object store, the answer to the CAPTCHA is considered invalid.

If, on the other hand, it is determined the slider position coincides with the correct missing block in the CAPTCHA with which the CAPTCHA answer is associated (916-Y), then the flowchart 900 continues to module 918 with sending a response to the CAPTCHA client device with a status of success. When the slider position distance as received from the client coincides with the position of the correct missing block B, as stored in the object store, the answer to the CAPTCHA is considered valid.

The flowchart 900 then continues to module 920 with sending a validation token with expiry to the CAPTCHA client device. The validation token with expiry is unique from the perspective of a CAPTCHA server and need not have any specific characteristics that identify it as a “validation token” or a “token with expiry.” The CAPTCHA client proffers the validation token with expiry to the CAPTCHA server or some other server that recognizes the validation token with expiry when performing further actions like data submission. For example, if a CAPTCHA is included in a form, then the user must solve the CAPTCHA and receive the validation token with expiry to submit data through the form.

The flowchart 900 then continues to module 922 with receiving the validation token with expiry in association with data submission. For the purposes of this example, the CAPTCHA server is intended to represent both the CAPTCHA server and any servers to which control is handed (e.g., a data server to receive a data submission request). As such, a data submission request can be characterized as being sent from the CAPTCHA client to the CAPTCHA server with the validation token with expiry regardless of the physical or logical architecture.

The flowchart ends at module 924 with validating the validation token with expiry. In a specific implementation, a token validator (such as the token validator 238) in a CAPTCHA server checks if the validation token with expiry is present in the object store matches the validation token with expiry provided by the CAPTCHA client device. If the validation token with expiry is not present (not shown in the flowchart 900), the client is informed that the status of token validation is failure, and a new CAPTCHA is shown. If the validation token with expiry has an expiration time that is greater than a current time when, or shortly after it is, received at the CAPTCHA server (also not shown in the flowchart 900), the client is informed that the status of the token validation is failure and may or may not be informed the failure is due to expiry; then a new CAPTCHA is shown. For example, if the validation token with expiry is present in the object store, a check can be made to see if the time elapsed since token creation is less than a predetermined time say, 120 seconds. Alternatively, a validation token with expiry may be removed from the datastore upon reaching an expiration time, which would cause the check to fail because the validation token with expiry is not present. These checks ensure a stale CAPTCHA's answer is not used unscrupulously. If the time elapsed is less than 120 seconds, the validation token with expiry is considered valid and data submission (or other data access) can proceed, else a request is sent to the client indicating token validation status as failure and a new CAPTCHA is presented.

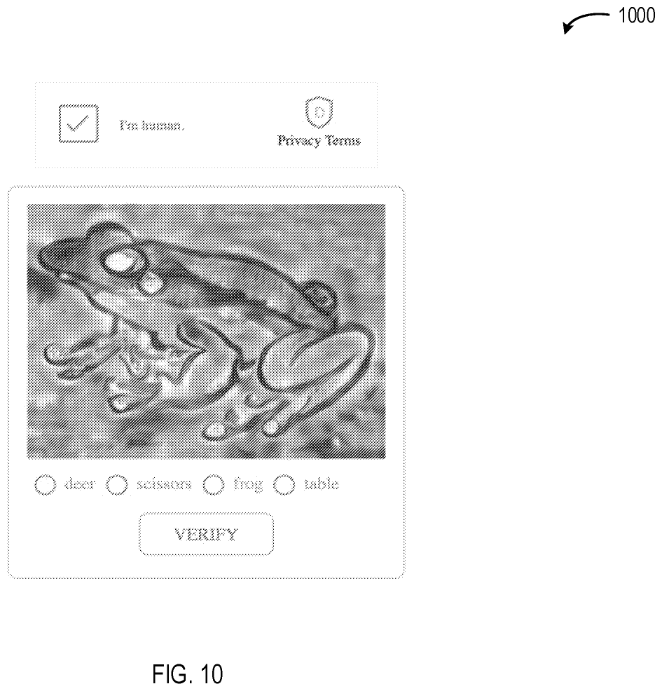

FIG. 10 depicts an example of Option-based Neural Style Transfer Image CAPTCHA 1000. In a specific implementation, an image selection engine (such as the image selection engine 216) picks a content image from a content image datastore (such as the content image datastore 212) and a style image from a style image datastore (such as the style image datastore 214) and the content image and style image selected by the image selection engine is fed to a neural style transfer engine (such as the neural style transfer engine 218), which generates a neural style transferred image in much the same manner as described above with reference to FIG. 2. A CAPTCHA puzzle generator, which is different than the CAPTCHA puzzle generator 206 of FIG. 2, associates multiple options (e.g., 4) to the CAPTCHA with the neural style transferred image. A user is presented with the neural style transferred image and is prompted to choose the answer that best describes the image.

1. A system comprising:
a Completely Automated Public Turing test to tell Computers and Humans Apart (CAPTCHA) image generator (204);
a CAPTCHA puzzle generator (206) coupled to the CAPTCHA image generator;
a CAPTCHA server (208) coupled to the CAPTCHA puzzle generator,
wherein, in operation:
the CAPTCHA image generator provides a neural style image to the CAPTCHA puzzle generator.
the CAPTCHA puzzle generator applies a puzzle to the neural style image to create a CAPTCHA;
the CAPTCHA server performs the CAPTCHA in association with a CAPTCHA client device (210).

2. The system of claim 1, wherein the CAPTCHA image generator includes a content image datastore (212), a style image datastore (214), an image selection engine (216) for selecting a content image from the content image datastore and a style image from the style image datastore, and a neural style transfer engine (218) for combining the content image and the style image into the neural style image.

3. The system of claim 1, wherein the CAPTCHA puzzle generator includes a hollow shape datastore (220), a hollow shape selection engine (222), a hollow block placement engine (224), a hollow block carving engine (226), and a slider block selection engine (228).

4. The system of claim 1, wherein the CAPTCHA puzzle generator associates multiple options with the neural style image.

5. The system of claim 1, wherein the neural style transfer engine includes a 5-layer of Visual Geometry Group (VGG)-19 encoder and decoder with Rectified Linear Unit (ReLU) as an activation function.

6. The system of claim 1, wherein the neural style transfer engine has style-agnostic generation ability with marginally compromised visual quality and execution efficiency.

7. The system of claim 1, wherein the neural style transfer engine is configured to carry out an image reconstruction process with content features transformed at intermediate layers with feed-forward passes.

8. The system of claim 1, wherein
the CAPTCHA server includes a CAPTCHA generator (230) that generates a CAPTCHA comprised of the neural style image with at least a missing block, a correct hollow block, and an incorrect hollow block;
when the CAPTCHA is displayed to a user of the CAPTCHA client device, the missing block is linked to a header of a range slider; when the header is dragged to a correct location, the missing block is moved to an inline location of the correct hollow block on the image; and
movement of the missing block is coordinated with movement of the header.

9. The system of claim 8, wherein the hollow block is debossed in nature.

10. The system of claim 1, wherein the CAPTCHA server includes a token generator (232), a CAPTCHA queue (234), an object datastore (236), a token validator (238), and a CAPTCHA validator (240).

11. A method comprising:
providing a neural style image;
applying a puzzle to the neural style image to create a Completely Automated Public Turing test to tell Computers and Humans Apart (CAPTCHA);
performing the CAPTCHA.

12. The method of claim 11, comprising
selecting a content image and a style image;
combining the content image and the style image to form the neural style image.

13. The method of claim 11, comprising:
selecting a hollow shape;
identifying a location in the neural style image for hollow block placement;
carving a hollow block from the neural style image;
selecting a slider block that matches the location.

14. The method of claim 11, comprising associating multiple options with the neural style image.

15. The method of claim 11, comprising using a 5-layer of Visual Geometry Group (VGG)-19 encoder and decoder with Rectified Linear Unit (ReLU) as an activation function.

16. The method of claim 11, comprising generating a neural style image with style-agnostic generation ability and marginally compromised visual quality and execution efficiency.

17. The method of claim 11, comprising carrying out an image reconstruction process with content features transformed at intermediate layers with feed-forward passes.

18. The method of claim 11, comprising generating a CAPTCHA comprised of the neural style image with at least a missing block, a correct hollow block, and an incorrect hollow block, wherein when the CAPTCHA is displayed to a user of the CAPTCHA client device, the missing block is linked to a header of a range slider; when the header is dragged to a correct location, the missing block is moved to an inline location of the correct hollow block on the image; and movement of the missing block is coordinated with movement of the header.

19. The method of claim 18, wherein the hollow block is debossed in nature.

20. The method of claim 11, comprising:
generating a token;
queuing a plurality of CAPTCHAs, including the CAPTCHA;
maintaining an object datastore that includes the CAPTCHA, the token, and a CAPTCHA client UID stored in association with one another;
validating the CAPTCHA;
validating the token.

21. A system comprising:
a means for providing a neural style image;
a means for applying a puzzle to the neural style image to create a Completely Automated Public Turing test to tell Computers and Humans Apart (CAPTCHA);
a means for performing the CAPTCHA.
